(19) United States
(12) Patent Application Publication
(10) Pub. No.: US 2010/0201036 A1
(43) Pub. Date: Aug. 12, 2010

(54) APPARATUS AND METHOD FOR FORMING PRODUCTS

(76) Inventor: Hendricus Antonius Hoogland, Wormer (NL)

Correspondence Address: HOFFMANN & BARON, LLP, 6900 JERICHO TURNPIKE, SYOSSET, NY, 11791, US

(21) Appl. No.: 12/516,252

(22) PCT Filed: Nov. 27, 2007
(86) PCT No.: PCT/NL2007/050599

§ 371 Date: Apr. 29, 2010

(30) Foreign Application Priority Data
Nov. 27, 2006 (NL) 1032947

(51) Int. Cl. B29C 45/56

(52) U.S. Cl. 264/328.7; 425/542

(57) ABSTRACT

An injection molding apparatus (1), comprising at least one mold cavity (9) and injection means (15) for injecting plastic into said at least one mold cavity, wherein at least a base part (13) provided and at least one module and attachment means for attaching said at least one module (10,11) on and/or in said base part, wherein in said at least one module at least one said mold cavity is provided, with at least one inlet opening, which mold cavity has at least one movable wall part (21) which is movable between at least a first, forwardly moved and a second, retracted position, to which end drive mean (23) are provided, which drive means are included at least partly in the base part.

The invention relates to an apparatus and method for forming products.

The invention relates in particular to an injection molding apparatus suitable for forming products, such as plastic products.

Injection molding apparatuses are known from practice. Use is then made of a mold with at least two relatively movable parts which together define a mold cavity with at least one injection opening. Thereon, for instance a hot runner of an injection device can be connected in order to introduce, with the mold closed, heated plastic into the mold cavity, under relatively great pressure. The plastic is then allowed to cool down in the mold, so that a relatively form-retaining plastic product is obtained.

With these known injection molding apparatuses, the two parts of the mold are to be attached onto two opposite plates of a press, while in the mold parts, different fittings for the injection molding apparatus are provided and included, such as cooling channels, feed channels, movement means and the like. Each mold that is used in such an injection molding apparatus must be specifically geared to both the respective product to be manufactured and to the injection molding apparatus.

From WO2004/024416, further, an injection molding apparatus and method are known wherein at least one mold cavity is provided which has at least one movable wall part, for adjusting the form and the volume of the mold cavity during injection molding. To that end, drive means are provided in the mold.

These known injection molding apparatuses are relatively complex in structure and use. As a result, they are, furthermore, relatively expensive, in particular if several types of products are to be manufactured. In particular molds in which drive means for a movable wall part are included are relatively expensive.

In a first aspect, the invention is characterized by at least one mold cavity and injection means for injecting plastic into said at least one mold cavity, wherein at least one base part is provided and at least one module and attachment means for attaching said at least one module onto and/or in said base part. In this at least one module, at least one mold cavity is provided, with at least one inlet opening, which mold cavity has at least one movable wall part which is movable between a first, forwardly moved and a second, retracted position. For moving said movable wall part, drive means are provided, which drive means are at least partly included in the base part.

By including the drive means at least partly in the base part, use can be made of relatively simple modules, which can, furthermore, be exchangeable. Here, in the or each module, at least one mold cavity is provided, while at least a number of the mold cavities are provided with a movable wall part which is drivable by the drive means in the base part. The base part can thus be a standard part that can be used with many different modules.

In a second aspect, the invention is characterized by at least one mold cavity and injection means for injecting plastic into said at least one mold cavity, wherein at least one base part is provided and at least one module. In the at least one module said mold cavity is provided, with at least one inlet opening, wherein in said base part at least a part of said injection means is provided. Attachment means are provided for attaching said at least one module on and/or in said base part in a manner such that the injection means link up with said at least one inlet opening.

By including the injection means at least partly in the base part, use can be made of relatively simple means, which can furthermore be exchangeable. Here, in the or each module, at least one mold cavity is provided, while each module or at least each mold cavity is provided with an inlet opening that can be coupled to the injection means in the base part. The base part can thus be a standard part that can be used with many different modules.

Preferably, in the base part, both injection means and drive means are provided.

In a particularly advantageous embodiment, the base part is included in, for instance designed as part of a press, such as an injection molding press. As a result, a particularly simple, integrated injection molding apparatus can be obtained, with relatively low weight of the moving parts. As a result, for instance the duration of an injection molding cycle can be shortened and/or more mold cavities per press can be utilized and/or a larger design choice is possible.

Preferably, the injection means and drive means are designed such that when the mold cavities are closed, and when at least one movable wall part is used, the material, in particular plastic, can be introduced while the or each movable wall part is moved from a retracted position to a forwardly moved position so fast that in the material, heat development is obtained, to be indicated as adiabatic heat development, at least as a result of mutual friction between molecules of the plastic and/or friction with the walls of the mold cavity. As a result, the temperature of at least a part of the plastic can be increased during use, or cooling can be retarded, so that filling the mold cavity can take place with less energy, at lower pressures and/or more rapidly. Furthermore, the plastic can then be introduced into the mold cavity at lower temperature than with conventional injection molding of a similar product with the same plastic.

The drive means can for instance be hydraulic, pneumatic, electric or mechanical, or a combination thereof, and can be settable, so that for instance velocity, acceleration, distance and/or movement pattern of movable wall parts to be driven therewith can be set. In particular, a series of drive means can be provided or, for instance, drive means comprising a series of driving elements that can each be coupled to a movable wall part in a module, several moving wall parts in a module and/or several moving wall parts in different modules. For instance, a matrix of tappet rods and/or pins and/or slides and/or spindles and/or pistons or such driving means can be provided. Preferably, these are individually drivable or at least settable but they can also be designed to be driven in groups.

The injection means can be provided with different channel parts, wherein valves can be provided for closing off one or more channel parts individually or in groups, depending on, for instance, the number and the type of module(s) used on the base part. In a further advantageous embodiment, one or more hot runner injectors can be provided in the base part, for instance in or adjacent the outlet openings of channel parts to which inlet openings of modules can be connected.

A product forming apparatus according to the invention is characterized by press means and an injection molding apparatus according to the invention, wherein the press means comprise at least a first press part and a second press part, while the or each module comprises a first and a second module part, between which at least a part of said mold cavity is formed, while the first module part is attached to the first press part and the second module part is connected to the second press part.

The invention further comprises a method, which is characterized in a first aspect by the use of at least one module, comprising a mold cavity with at least one inlet opening, which module is attached to a base part in a manner such that said at least one inlet opening is connected to a dispensing opening of a channel part of injection means included at least partly in the base part, whereupon, with the aid of the injection means, plastic is introduced into the at least one said mold cavity for forming a product.

In clarification of the invention, embodiments thereof will be further described on the basis of the drawing. In the drawing:

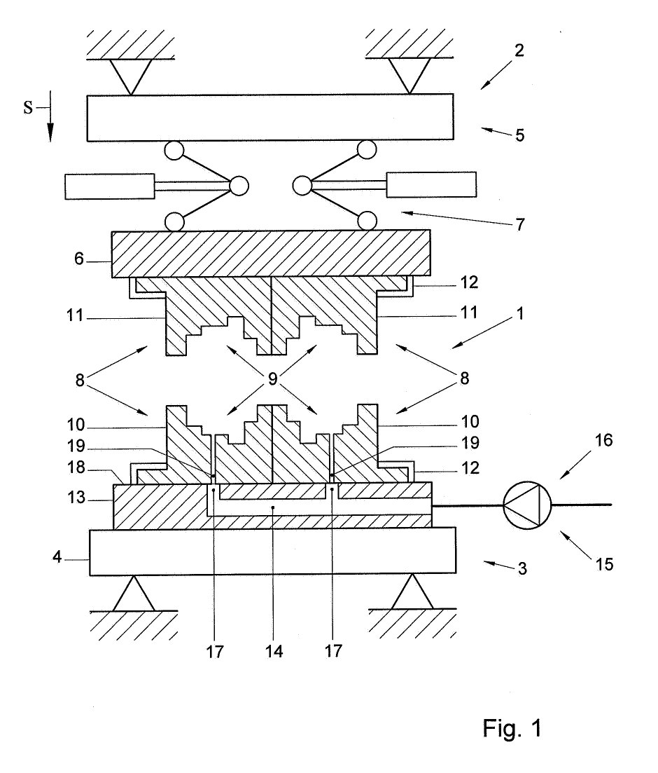

FIG. 1 schematically shows an injection molding apparatus according to the invention in a press;

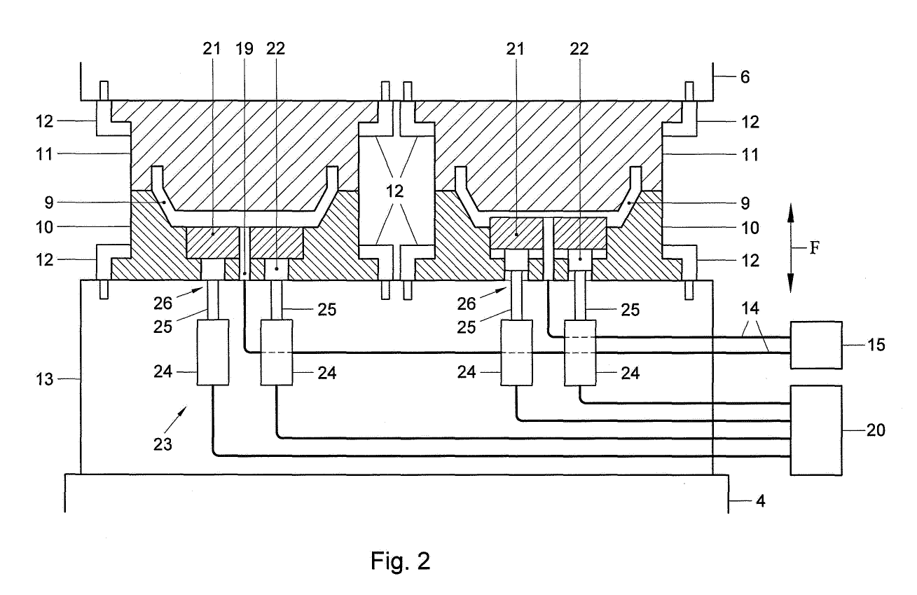

FIG. 2 schematically shows an injection molding apparatus according to the invention, in partly cross-sectional side view;

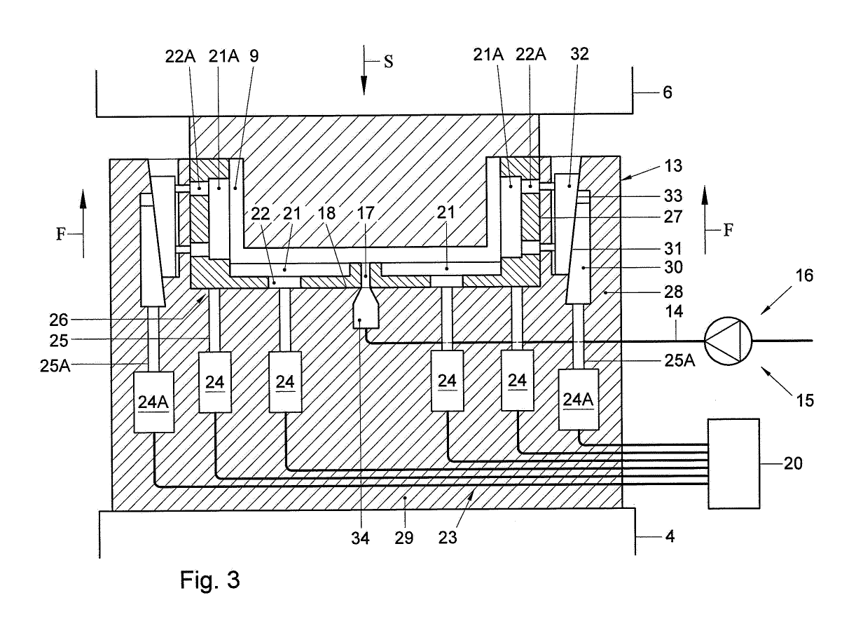

FIG. 3 schematically shows an injection molding apparatus according to the invention, in an alternative embodiment, in partly cross-sectional side view;

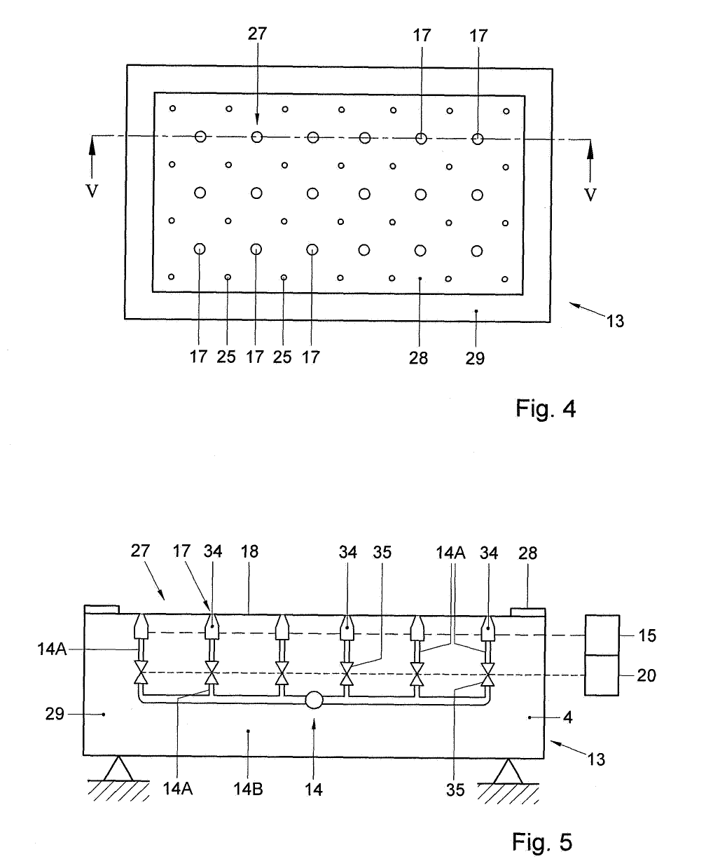

FIG. 4 schematically shows, in top plan view, a base part of an injection molding apparatus according to the invention;

FIG. 5 schematically shows, in cross-sectional side view along the line V-V in FIG. 4, a base part according to the invention in a further alternative embodiment; and

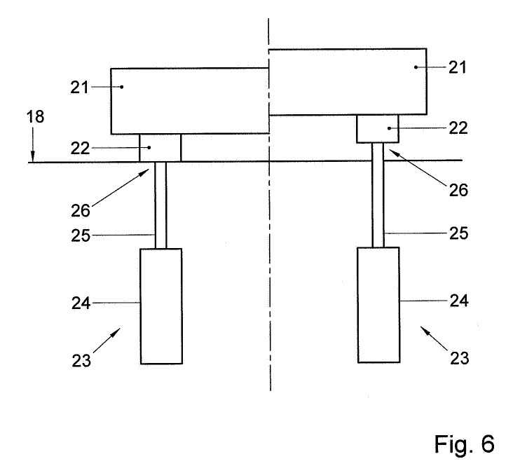

FIG. 6 schematically shows, in side view, a movable wall part of a module and drive means in a base part according to the invention.

In this description, identical or corresponding parts have identical or corresponding reference numerals. In this description, the starting point will be an injection molding apparatus and method for forming plastic products. However, the invention is not limited thereto. Other materials too, such as light metal, can be processed in such an apparatus. In this description, an injection molding apparatus is the starting point wherein, in a conventional manner, use is made of a known heating device and an apparatus that generates feed pressure for the plastic, such as, for instance, a screw feeder provided with heating means. This will be generally indicated as feeder device. However, also other types of feeder means can be used. In the Figures, these feeder means are represented as part of the injection means.

In FIG. 1, schematically, in partly cross-sectional side view, an injection molding apparatus 1 according to the invention is shown, included in a press 2. The press 2 has a first press part 3, for instance the stationary plate 4 and a second press part 5, for instance the moving plate 6. These press parts 3, 5 can be moved together and apart in the customary manner, for instance hydraulically or with a scissor mechanism 7. Customarily, these movements are used for opening and closing a mold. As such presses are known to the skilled person, it will not be discussed further.

As is clearly visible in FIGS. 1 and 2, two modules 8 are attached between the plates 4, 6. In principle, each module forms a part of a mold, in the sense that they each comprise at least one mold cavity 9. Each module 8 comprises a first module part 10 and a second module part 11, which parts each comprise, in a customary manner, a part of the mold cavity 9 and define, when placed in a moved-together position, as shown in FIG. 2, the closed mold cavity. The second module parts 11 are attached to the moving plate 6 with clamps 12. The first module parts 10 are attached with the aid of clamps 12 to a base part 13, which base part 13, in this embodiment, is secured to the stationary plate 4 of the press 2, for instance by a bolt connection (not shown). For the attachment of the module parts 10, 11 and the base part 13, naturally, all sorts of known, suitable means can be utilized.

In the embodiment shown in FIG. 1, the base part 13 comprises a channel system 14, as part of injection means 15. For injecting plastic into the mold cavities 9, the channel system is connected to a feeder device 16 with which plastic can be melted and be introduced under pressure into the channel system 14. Here, for the sake of simplification, the feeder device 16 is indicated with a pump symbol. The channel system 14 comprises a number of outlet opening 17 in the surface 18 of the base part 13 onto which the modules 8 are attached. The modules 8 are each provided with at least one inlet opening 19 which fittingly links up with at least one outlet opening 17 of a channel part 14A, B of the channel system 14. Through placement of the base part 13 on the plate 4, a universal attachment element is provided on which different modules 8 can be placed, depending on the products to be manufactured.

In FIGS. 1 and 2, two modules 8 are shown, each provided with one mold cavity 9. These mold cavities can be identically shaped, for instance for manufacturing identical products, but can also be different, for injection molding different products or parts thereof in one cycle. Modules 8 can be also provided with several mold cavities 9, for instance side by side, wherein each mold cavity can be provided with an inlet opening 19 or one inlet opening can be provided for several mold cavities, for instance mutually connected by a channel linking up with the inlet opening. Further, modules can be designed as stack molds, wherein the channel can pass a first layer of mold cavities to arrive at a second or further layer. In general, different types and numbers of modules 8 can be placed on a base part 13, while each time at least one dispensing opening is connected to at least one inlet opening of a mold cavity in each of the modules that are used.

In FIG. 2, in further detail, schematically, two modules 8 are shown, between a movable plate 6 and the fixed plate 4, or at least the base part 13, in closed condition. With this embodiment, the second module parts 11 are designed as male parts, the first as female parts 10. Therebetween for instance tray-shaped mold cavities 9 are recessed. Here, the channel system 14 is represented in a simplified manner with single drawn lines, connected to injection means and control means 15, 20 for control of the injection of plastic into the mold cavities 9. In the first module parts 10, each time, a part of the wall of the mold cavity 9 is designed as a movable wall part 21, for instance a slide. This movable wall part 21 rests, for instance with the aid of a few projections 22, on drive means 23 which are included in the base part 13. The projections 22 or the movable wall part 21 are accessible from the outside of the module 8, in this case in the surface 24 facing the base part. By pressing against and/or pulling the projections and/or the movable wall part 21, this can be moved between a retracted position as schematically represented in FIG. 2 and FIG. 6 on the left hand side, and a forwardly moved position, as schematically represented in FIGS. 2 and 6 on the right hand side. With this, the volume of the closed mold cavity 9 can be adjusted in a simple manner, as will be further described.

In this embodiment, the drive means 23 are represented as piston-cylinder assemblies 24, for the sake of simplification further indicated here as cylinders 24. These cylinders 24 have a tappet rod 25 which extend in a direction of movement F towards the movable wall parts 21, and whose ends 26 abut against or can come into abutment with the projections 22 and/or the movable wall part 21, for setting this/these into motion. The cylinders 24 are coupled to the control means 20 together, in groups or, as in this embodiment, individually. As a result, for each cylinder it can be set at which moment in an injection molding cycle, how fast and how far the respective movable wall part 21 is moved. In the exemplary embodiment shown, the movable wall part 21 extends around the inlet opening 19 or at least around the channel part 14A linking up therewith. The ends 26 of the tappet rods are preferably not connected to the projections 22 or movable wall parts 21 other than through abutment or, for instance, in a form-fitting manner, but can also be connected thereto by means of, for instance, magnetism, screw thread, clamping or snap connection or an otherwise detachable coupling in a manner such that both a pushing and a pulling movement can be transferred thereto. The movable part 21 can furthermore function as ejector.

With an apparatus 1 according to the invention, a product or series of products can be manufactured as follows. One or more modules 8 are placed in the press 2, as shown in FIGS. 1 and 2, while inlet openings 19 are connected to outlet openings 17. Optionally, first, other modules 8 are removed. Outlet openings 17 in the base part 13 that are temporarily not used in an injection molding process are sealed off, for instance by the modules 8 or by separately provided stoppers (not shown) which can be secured, for instance screwed in, for instance, the outlet opening 17. The movable wall parts 21 of the module(s) 8 is/are placed such that it, or at least the projections 22 thereof can each time thrust against one of the tappet rods 25 of the cylinders 24 or can be stricken thereby, while not always all cylinders 24 and tappet rods 25 need be used. The or each movable wall part 21 is brought into a retracted position as shown in, for instance, FIG. 2 at the left module 8, and plastic is introduced in melted condition into the mold, with a temperature, for instance, just above the melting point. After the mold cavity with a relatively large volume is virtually completely filled with the plastic, or at least the required plastic has been introduced therein for the larger part, with the plastic experiencing relatively little resistance as a result of the relatively large dimensions of the mold cavity, the movable wall part 21 is moved relatively rapidly (high acceleration and velocity) over a relatively short distance (smaller than the wall thickness of the product to be formed) to a forwardly moved position, schematically shown in FIG. 2 in de right hand module 8. Here, a part of the plastic is urged away and, as a result of friction, heat is formed in the plastic. Consequently, the temperature of the plastic is locally increased or at least the cooling off thereof is retarded, so that the pressure required for filling the entire mold cavity is relatively low in relation to conventional injection molding of an identical product, with the same plastic. Also, products can be manufactured through injection molding which are thinner and larger than with conventional injection molding on a similar press. As the cylinders can be controlled individually or in groups, each time, the optimal movement pattern can be regulated, while the cylinders that are not used in a respective injection molding cycle can be halted. With injection molding with other modules, still other and/or the same cylinders can be controlled as drive means.

The drive means can be arranged in any desired, known manner, for instance hydraulically, pneumatically, electrically, mechanically and/or combinations thereof.

In FIG. 3, an alternative embodiment of an injection molding apparatus 1 according to the invention is shown, wherein the base part 13 is substantially tray-shaped. In this embodiment, in the condition shown in FIG. 3, one module 8 is shown, but naturally, again, several modules 8 can be used simultaneously. Insofar as the parts are identical, they have been given the reference numerals as in FIGS. 1 and 2, and are only described insofar as required for a proper understanding of the invention.

In this embodiment, a first module part 10 is included virtually completely and fittingly in a cavity 27 in the base part 13, bounded by walls 28 which extend from a bottom part 29 of the base part 13. In the bottom part 29, in this case, four cylinders 24 are shown, comparable to those shown in and described on the basis of FIG. 2, and two further cylinders 24A as part of the drive means 23. During use, at least a number of the series of cylinders 24 drive movable wall parts 21 of the part of the mold cavity 9 in the first module part 10, in this case in a bottom-forming part thereof. The two further cylinders 24A are designed for driving a wedge 30 which is included in a wall 28, which wedge 30 abuts with an inclined surface 33 against a second wedge 32 which, also with an inclined surface 33, abuts against the inclining surface 32 of the first wedge 30. By moving the tappet rod 25A of these further cylinders 24A in the direction F away from the fixed plate 4, the wedges 30, 32 are moved relatively to each other, so that the second wedge is urged in the direction of the cavity 27. On the second wedges 32, projections 22A are provided which reach near, or into the cavity 27 and which, therein, can come to lie against moving wall parts 21A inside of the first module 10. As a result, these further moving wall parts 21A can be moved to and fro between a forwardly moved and a retracted position, relative to the cavity 27. With such an injection molding apparatus, wall parts can be moved that include an angle with the closing direction S of the press, for instance an angle of 90 degrees. Also an angle deviating from 180 degrees can be obtained by selecting a suitable direction of the projections and/or the moving wall part 21A. Naturally, large numbers of cylinders 24 can be placed with tappet rods side by side and/or one behind the other, as well as outlet openings 17, which, once more, can be drivable together, individually and/or in groups by the control means 20, for instance an injection molding automaton or computer.

With such an injection molding apparatus 1, products can be formed in the same or comparable manner as discussed hereinabove.

In this embodiment, an outlet opening (of which only one is shown) is provided with a hot runner nozzle 34 that can be opened and closed and otherwise regulated by the control means for an optimal injection molding process.

In FIG. 4, schematically, in top plan view, a base part 3 is shown, for instance comparable to that used in an injection molding apparatus 1 according to FIG. 3, while the module 8 is removed. Here, the base part is designed as a fixed plate 4 of a press, but can also be designed as a separate base part 13, and is provided with a bottom part 29 and a wall 28 around a cavity 27. In the bottom part 29, a matrix of outlet openings 17 is provided, of which, in FIG. 5, as cross section, it is clearly visible that they each comprise a hot runner nozzle 34 or similar shutoff. Around and between the outlet openings 17 is provided a matrix of tappet rods 25 of cylinders 24 as driving means 23. In FIG. 5 it is shown that the wall 28 can for instance be relatively low and can function as positioning means. However, this can also be designed as in FIG. 3. The channel system 14 comprises a main channel 14B and a number of channel parts 14A extending away therefrom, each of which terminating into an outlet opening 17 or, more particularly, a hot runner nozzle 34 in the surface 18. In each of the channel parts 14A, a valve 35 is provided, with which the channel parts can be individually closed off, so that each time, the desired outlet openings and/or hot runners 34 can be selected, depending on the type and number of modules to be placed.

It is clear that with an injection molding apparatus for instance expensive, technically complicated, voluminous, sensitive and/or universal parts, for production processes for different products can be accommodated in one or more base parts. The modules forming the molds proper, at least comprising the mold cavities, can be manufactured to be relatively simple, light, little voluminous and/or presenting a greater designer choice, even when moving wall parts are provided therein.

The invention is not limited in any manner to the embodiments represented in the drawing and the description. Many variations thereon are possible within the framework of the invention as outlined by the claims.

Different combinations can be used of the embodiments shown and/or parts thereof. The injection means, in particular the outlet openings and/or inlet openings can be designed differently and for instance be provided opposite moving wall parts, can be provided in the moving plate 6 of the press 2 while the base part 13 is provided on the stationary plate 4 or vice verse, and comprise buffer means, mixing means, coloring means and the like. Also, both on the moving and on the fixed plate 4, 6, a base part 13 can be placed, one provided with, for instance, the drive means and the other with the injection means or parts thereof. The drive means can be designed to be completely or partly different, for instance as a buffer which is filled, at least pressurized (loaded) when the module parts 10, 11 are brought onto each other, and can discharge by, for instance, pulling a switch, so that all at once, the buffered energy is released for moving the movable parts. The or each base part can have any desired shape and/or dimension. At least one, and preferably several parts of the drive means, such as cylinders, can be designed so as to be settable, so that the direction of operation F thereof can be set. As a result, modules can be utilized with movable parts that are movable in different directions.

These and many comparable modifications are understood to fall within the framework of the invention as outlined by the claims.

1. An injection molding apparatus, comprising at least one mold cavity and injection means for injecting plastic into said at least one mold cavity, wherein at least a base part is provided and at least one module and attachment means for attaching said at least one module on and/or in said base part, wherein, in said at least one module, at least one said mold cavity is provided, with at least one inlet opening, which mold cavity has at least one movable wall part that is movable between at least a first, forwardly moved and a second, retracted position, to which end drive means are provided, which drive means are included at least partly in the base part.

2. An injection molding apparatus, comprising at least one mold cavity and injection means for injecting plastic into said at least one mold cavity, wherein at least a base part is provided and at least one module, wherein, in said at least one module, at least one said mold cavity is provided, with at least one inlet opening, preferably according to claim 1, and wherein, in said base part, at least a part of said injection means is provided, while attachment means are provided for attaching said at least one module on and/or in said base part in a manner such that the injection means link up with said at least one inlet opening.

3. An injection molding apparatus according to claim 1, wherein the drive means comprise at least one operating element which is drivable in the direction of a module mounted on and/or in the base part, in a manner such that the operating element is in contact with or can be brought into contact with said at least one movable wall part.

4. An injection molding apparatus according to claim 3, wherein a series of operating elements are provided in said base part.

5. An injection molding apparatus according to claim 4, wherein at least a number of the operating means are individually controllable.

6. An injection molding apparatus according to claim 4, wherein at least a number of the operating means are jointly controllable.

7. An injection molding apparatus according to claim 1, wherein said base part is part of a press.

8. An injection molding apparatus according to claim 1, wherein in and/or on said base part, a series of modules are arranged, which are provided with at least one said mold cavity.

9. An injection molding apparatus according to claim 1, wherein said base part comprises a series of channel parts which form part of the injection means, wherein at least one valve is included for closing off at least one channel part with respect to at least one other channel part.

10. An injection molding apparatus according to claim 9, wherein said channel parts each have a dispensing opening for connection to an inlet opening of a module or mold cavity.

11. An injection molding apparatus according to claim 1, wherein the injection means comprise at least one hot runner, preferably provided in the base part on a side facing the attachment means for the or a said module.

12. A product forming apparatus, comprising press means and an injection molding apparatus according to claim 1, wherein the press means comprise at least a first press part and a second press part, wherein the or each module comprises a first and a second module part, between which at least a part of said mold cavity is formed, while the first module part is attached to the first press part and the second module part is connected to the second press part.

13. A product forming apparatus according to claim 12, wherein the base part is included in one of the press parts.

14. An assembly of a base part and a series of modules for forming an injection molding apparatus according to claim 1, wherein the modules are exchangeable on and/or in the base part, such that with the same base part each of the modules and/or a combination of two or more of said modules, together with the base part, can form part of an injection molding apparatus according to claim 1.

15. A method for manufacturing products, wherein at least one module, comprising a mold cavity with at least one inlet opening, is attached to a base part in a manner such that said at least one inlet opening is attached on a dispensing opening of a channel part of injection means included at least partly in the base part, whereupon, with the aid of the injection means, plastic is introduced into the at least one said mold cavity for forming a product.

16. A method according to claim 15, wherein through placement of the or each module, in at least one module, a movable wall part of a respective mold cavity is brought into contact with operating means for movement of the respective movable wall part, wherein the operating means are at least partly included in the base part.

17. A method according to claim 15, wherein prior to placing the or each module, at least one module of the base part is removed from a respective dispensing opening and/or operating means, while the removed module differs from the module to be placed, especially as to the or a mold cavity included therein.

18. An injection molding apparatus according to claim 2, wherein the drive means comprise at least one operating element which is drivable in the direction of a module mounted on and/or in the base part, in a manner such that the operating element is in contact with or can be brought into contact with said at least one movable wall part.

19. A product forming apparatus according to claim 12, wherein the modules are exchangeable on and/or in the base part, such that with the same base part each of the modules and/or a combination of two or more of said modules, together with the base part.
